(19) United States
(12) Patent Application Publication
(10) Pub. No.: US 2006/0226347 A1
(43) Pub. Date: Oct. 12, 2006

(54) System and method for detecting leaks from a member

(76) Inventors: Frank Joseph Leitch, North Tonawanda, NY (US); Brian J. Coyle, Orchard Park, NY (US); Robert Charles Gmerek, Burt, NY (US)

Correspondence Address: DELPHI TECHNOLOGIES, INC., M/C 480-410-202, PO BOX 5052, TROY, MI, 48007, US

(21) Appl. No.: 11/101,211

(22) Filed: Apr. 7, 2005

(51) Int. Cl. G01V 8/00; G01N 21/85

(52) U.S. Cl. 250/222.2; 250/573

(57) ABSTRACT

A system and a method for detecting leaks from a member are disclosed. The system includes the member, a gas source, and a laser vibrometer. The member has an inlet and an outlet and defines a cavity therebetween. The gas source charges the cavity with a gas and continues a flow of the gas into the cavity to maintain the charge. The laser vibrometer detects vibrations caused by the continued gas flow after charging to indicate leakage of the gas from the member.

### TECHNICAL FIELD

The subject invention relates to a system and method for detecting leaks from a member, and more specifically to a non-destructive system and method for detecting leaks from a heat exchanger.

### BACKGROUND OF THE INVENTION

Various systems and methods are well known to those skilled in the art for detecting leaks from a member defining a cavity. One such system submerges the member in a pool of liquid. Air bubbles that are trapped inside the member escape from leaks inside the cavity. Visual techniques are employed to detect the air bubbles escaping from the member. Alternatively, detectors, such as laser detectors, may be employed to emit a beam of light through the pool of liquid to measure the air bubbles passing through the beam of light. If a certain amount of air bubbles pass through the beam of light, then the member is determined to have a leak. One drawback to such a method is that the member has to be submerged in the liquid. This results in either the member not being useable and being discarded or the member must be dried prior to rejoining the manufacturing process. If the member is not dried, then the liquid may contaminate the manufacturing process. Another drawback is that the visual methods are at best eighty percent effective to detect leaks as a result of air bubbles that adhere to the surface and become dislodged during testing. These air bubbles are detected and the member will be falsely rejected as having a leak.

Another related art system and method for detecting leaks from a member utilizes mass spectrometry. The cavity of the member is filled with a gas, such as helium or a helium/air mixture. The member is then placed into a detector to detect gas escaping from the cavity. The mass spectrometer scans the air about the cavity, which is different from the air inside the cavity, and monitors for the air trapped inside the cavity to be present. If the detector detects the gas outside of the cavity then the member is rejected for having a leak. However, the mass spectrometry methods tend to produce false positives and the members are rejected even though the members do not have a leak.

Still another system and method of testing for leaks is a destructive testing method that in the member cuts the member into two parts. The internal structure of member is examined for structural deficiencies that indicate a leak, such as perforations or tears. One drawback of destructive testing methods is that if the member did not have a leak, the member has been destroyed which wastes valuable resources. Another disadvantage is that only relatively large deficiencies will be detected, even though smaller deficiencies are present. Accordingly, it would be advantageous to detect the leaks without having to destroy the member.

Lasers have become increasingly useful for testing structural integrity of components. One such system utilizes laser vibrometers to detect structural integrity of a component having an internal structure. As understood by those skilled in the art, laser vibrometers generally include a laser for generating a beam of light and a detector for detecting the beam of light after the beam of light has been reflected. The beam of light has a first pattern, such as frequency or velocity, and once the beam of light is reflected, the beam of light has a second pattern different from the first pattern. The detector is connected to a processor for comparing the first and the second patterns to determine the structural integrity of the component.

For example, the component is vibrated to detect loose or poor bonding inside the component. To determine if poor bonding is present, a component having all good bonds is vibrated and the beam of light is reflected off the component as it is vibrated. A vibration device is coupled to the component for physically shaking and vibrating the component. The pattern of the beam of light is detected and recorded. Next, a component having a percentage of loose bonds is vibrated and the beam of light pattern is again detected. This continues until a scale can be developed for loose bonds versus the beam of light pattern. Then, a component having an unknown structural integrity is vibrated and the beam of light pattern is detected. The pattern is compared to the scale and the amount of loose bonds inside the component can be detected. However, such a method requires developing a scale for comparison for each type of member. Additionally, small variations within the vibration of the member may result in different patterns that would result in false rejections, such as weight, placement, and the like.

The related art systems and methods are characterized by one or more inadequacies. Specifically, the systems and methods of the related art result in the member being destroyed or submerged in a liquid. Further, these systems and methods are expensive to incorporate into existing manufacturing processes and require additional testing after the manufacturing processes. Another disadvantage of such systems and methods is that false rejections occur frequently and members having small leaks go undetected. Therefore, it would be advantageous to provide a system and method that overcomes these inadequacies.

### SUMMARY OF THE INVENTION

The subject invention provides a system and a method for detecting leaks from a member. The system includes the member, a gas source, and a laser vibrometer. The member has an inlet and an outlet and defines a cavity therebetween. The gas source is coupled to the inlet for charging the cavity with a gas and for continuing a flow of the gas into the cavity to maintain the charge. The laser vibrometer detects vibrations caused by continued gas flow after charging to indicate leakage of the gas from the member.

The method, according to the subject invention, includes the steps of sealing the outlet to prevent gas from escaping from the cavity and connecting the inlet to the gas source for supplying the gas to charge the cavity. Further, the method includes the steps of continuing to maintain a flow of gas into the cavity after charging and detecting vibrations caused by continued gas flow into the cavity to indicate leakage of the gas from the member.

The subject invention overcomes the inadequacies that characterize the related art assemblies. Specifically, the system and method of the subject invention allow for non-destructive leak detection of members and do not require the members to be submerged in a liquid. Further, the system and method is inexpensive to incorporate into existing manufacturing processes and may be directly implemented into these manufacturing processes. Another advantage of the subject invention is that even small leaks may be detected since minute air movement will cause vibrations that will be detected. Still another advantage is that the subject invention reduces false rejections of members that do not have leaks since there will be no vibrations if a leak is not present.

### BRIEF DESCRIPTION OF THE DRAWINGS

Other advantages of the present invention will be readily appreciated, as the same becomes better understood by reference to the following detailed description when considered in connection with the accompanying drawings wherein:

FIG. 1 is a perspective view of a system for detecting leaks from a member utilizing a laser vibrometer;

FIG. 2 is another perspective view of the system including a gas source, a laser, and a detector;

FIG. 3 is a cross-sectional view of a vibration module coupled to the member having a first embodiment of a vibrator disposed therein for vibrating as air passes therethrough;

FIG. 4 is a cross-sectional view of the vibration module coupled to the member having a second embodiment of the vibrator disposed therein for vibrating as air passes therethrough;

FIG. 5 is a cross-sectional view of the vibration module coupled to the member having a third embodiment of the vibrator disposed therein for vibrating as air passes therethrough;

FIG. 6 is a graphical illustration of an output generated by a processor as a result of reflecting a beam of light off a member having no leaks; and

FIG. 7 is a graphical illustration of an output generated by a processor as a result of reflecting a beam of light off a member having leaks.

### DETAILED DESCRIPTION OF THE INVENTION

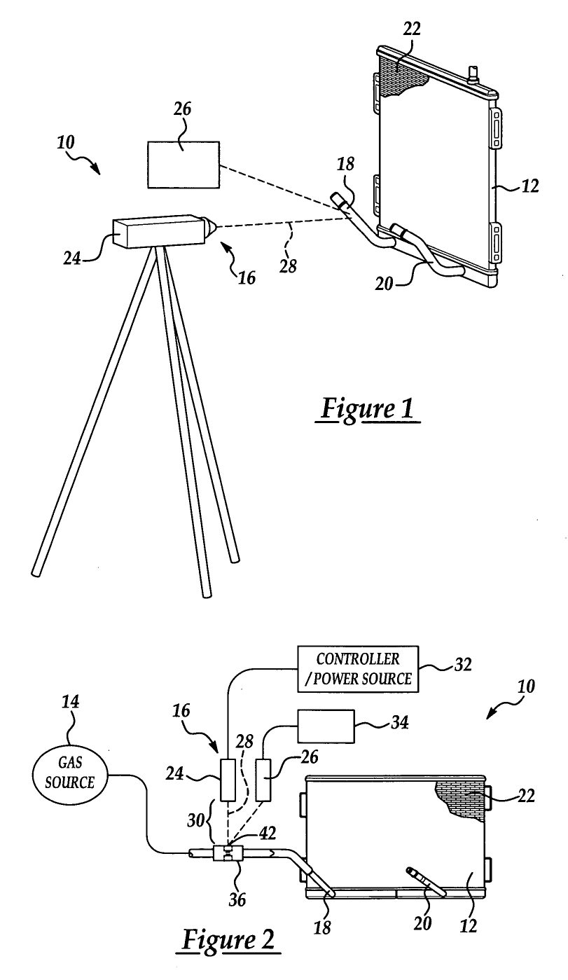

Referring to the Figures, wherein like numerals indicate corresponding parts throughout the several views, a system for detecting leaks from a member 12 is shown generally at 10 in FIG. 1. The system 10 is particularly useful in detecting small leaks, such as, less than twenty-five cubic centimeters, and does not require destroying the member 12 or submerging the member 12 in a liquid.

Referring to FIGS. 1 and 2, the system 10 comprises the member 12, a gas source 14, and a laser vibrometer 16. The member 12 has an inlet 18 and an outlet 20 and defines a cavity 22 therebetween. The member 12 preferably houses a fluid, such as a gas or a liquid within the cavity 22 such that if the member 12 had leaks, then the fluid would escape from the cavity 22. The member 12 is generally subjected to lower pressures during use, such as less than 100 pounds per square inch gauge (psig). The member 12 is more preferably utilized with automobile components, such as, but not limited to, radiators, condensers, and heater cores. It is to be appreciated that other applications, such as commercial, industrial, or household, may be utilized with the system 10 without deviating from the subject invention.

The gas source 14 is coupled to the inlet 18 for charging the cavity 22 with a gas and for continuing a flow of the gas into the cavity 22 to maintain the charge. Such a system is illustrated in FIG. 2. Depending upon the size of the cavity 22, the amount of gas required to charge the member 12 may vary. For example, a radiator having a standard size for an automobile may be charged with from sixty to seventy pounds of gas from the gas source 14. The gas source 14 may supply any type of gas and a preferred gas is air. Different types of gas may be supplied for different applications or for detecting various sizes of leaks.

The laser vibrometer 16 detects vibrations caused by continued gas flow after charging to indicate leakage of the gas from the member 12. As understood by those skilled in the art, the laser vibrometer 16 generally includes a laser 24 and a detector 26. The laser 24 generates a beam of light 28 and directs the beam of light 28 toward the member 12. The laser 24 is positioned an appropriate distance from the member 12, commonly referred to as the focal length 30, for emitting the beam of light 28. The focal length 30 of the laser 24 may be adjusted to detect different sized leaks from the member 12. The detector 26 detects the beam of light 28 reflected by the member 12. The laser vibrometer 16 may also include a controller 32 or power source connected to the laser 24 and a processor 34, such as in a computer, connected to the detector 26.

A vibration module 36 is coupled to the member 12 for vibrating in response to continued gas flowing therethrough. Said another way, the vibration module 36 amplifies the vibrations of the air moving into the member 12 since the amount of air moving may be minute. The vibration module 36 may be coupled to the inlet 18 or integrally formed within the member 12. By attaching the vibration module 36 to the inlet 18, the system 10 of the subject invention can be used to test random members as the members 12 are manufactured. Alternatively, if the vibration module 36 is integrally formed in the member 12, then every member 12 that is manufactured may be tested as a step in the manufacturing process.

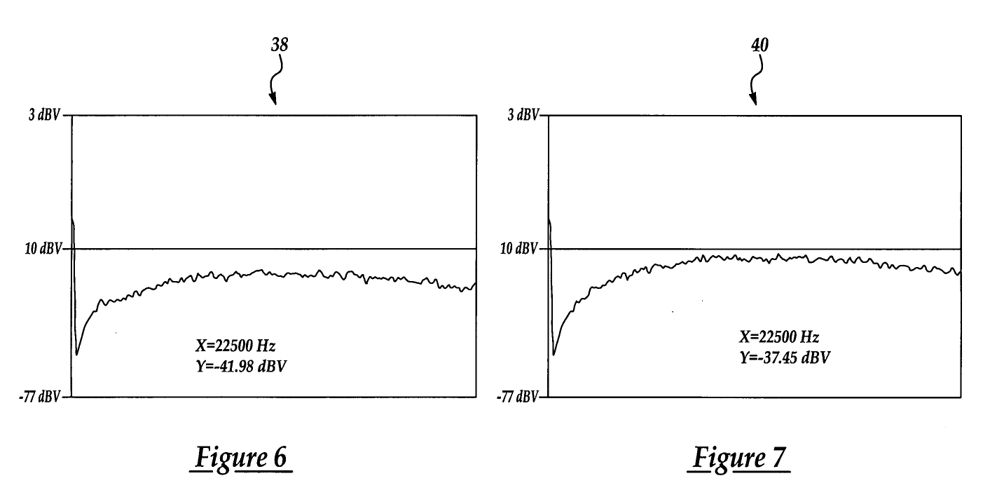

Preferably, the laser 24 directs the beam of light 28 towards the vibration module 36. The beam of light 28 is emitted having a first pattern 38 (shown in FIG. 6), such as a velocity response. As the air moves through the vibration module 36, the vibration module 36 amplifies the vibrations for detection. The vibrations then alter the beam of light 28 to have a second pattern 40 (shown in FIG. 7) different from the first pattern 38. The detector 26 detects the second pattern 40 to indicate that the member 12 has a leak.

Referring back to FIG. 2, in order to accurately detect the vibrations, the vibration module 36 should be positioned substantially perpendicular to the beam of light 28. Further, the vibration module 36 may include a reflection point 42 that is substantially planar for reflecting the beam of light 28 toward the detector 26. The reflection point 42 is planar, or flat, to ensure that the vibrations are accurately detected. Since only a minute amount of air may be flowing into the member 12, the vibrations from the vibration module 36 may be slight. Therefore, the flat reflection point 42 will provide an accurate representation of the vibrations in the reflected beam of light 28.

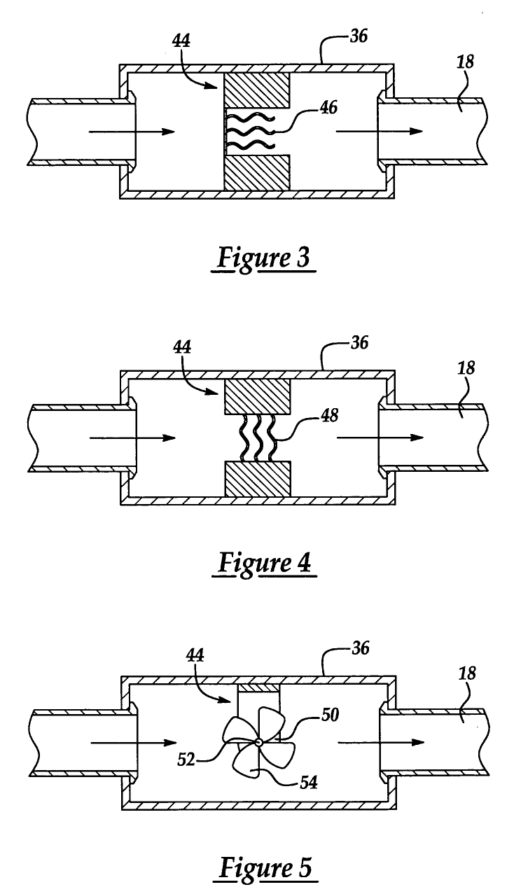

With reference to FIGS. 3 to 5, a vibrator is disposed in the vibration module 36 for vibrating as the gas flows through the vibration module 36 and is shown generally at 44. The vibrator 44 is selected from at least one of a flap 46 connected at one end, a flexible membrane 48 connected at both ends, and a vane 50 for rotating about a shaft 52. The vibrator 44 may be disposed parallel or transverse to the continued flow of gas through the vibration module 36. Referring to FIG. 3, the flap 46 is illustrated as connected at one end and parallel to the continued flow gas. The flap 46 may include a lightweight metal or plastic. More preferably, the lightweight metal is aluminum. A suitable flexible membrane 48 for connecting at both ends may include a rubber, plastic, or lightweight metal, which is illustrated in FIG. 4. The membrane 48 is illustrated as positioned perpendicular to the flow of the continued gas. FIG. 5 illustrates the suitable vane 50 including the shaft 52 mounted to the vibration module 36 having an impeller 54 rotatable about the shaft 52. Depending upon the amount of air flowing through the member 12, different vibrators 44 may be employed so long as the vibrator 44 amplifies the vibrations as air flows therethrough.

In operation, the subject invention provides a unique method of detecting leaks from the member 12 without having to destroy the member 12 or submerge the member 12 in a liquid. Referring back to FIG. 2, the outlet 20 of the member 12 is sealed to prevent gas from escaping from the cavity 22. The gas source 14 is connected to the inlet 18 and the gas is supplied to charge the cavity 22. It is to be appreciated that the member 12 may only include the inlet 18 and not have the outlet 20, in which case, the outlet 20 would not require sealing. Next, the flow of gas is continued into the cavity 22 after charging. In other words, once the cavity 22 is full of the gas, the gas supply continues to supply the gas into the inlet 18; however, there will be no additional flow into the cavity 22 if the member 12 does not have any leaks. If the member 12 has a leak, then the continued gas will flow into the cavity 22. The flowing of the gas into the cavity 22 will cause vibrations, which are detected. The detected vibrations may then be analyzed to determine the amount of gas that was leaking from the member 12, as illustrated in FIGS. 6 and 7, which will be described in more detail below.

In the preferred embodiment, the vibration module 36 is coupled to the inlet 18 of the member 12 and the beam of light 28 is reflected off the vibration module 36. The beam of light 28 is emitted having the first pattern 38 such that after being reflected the beam of light 28 has the second pattern 40 if the member 12 leaks. Referring again to FIG. 2, the processor 34 has been connected to the detector 26 to generate a graphical output of the first and the second patterns 38, 40 of the beam of light 28. The member 12 has been charged and the gas source 14 continues the flow of gas at seventy pounds per square inch.

FIG. 6 represents the graphical output of the first pattern 38 of the beam of light 28 after being reflected. FIG. 6 was generated without any air flowing into the cavity 22 and therefore the detected pattern represents the first pattern 38 without vibrations. Likewise, this same pattern would be detected if the member 12 does not have any leaks. FIG. 7 represents the graphical output of the second pattern 40 when air is flowing into the member 12 and the member 12 is known to have a leak of about eight cubic centimeters. Comparing the two graphical outputs, FIG. 7 has a higher peak than that of FIG. 6. Therefore, these graphical outputs could be used to determine that a leak was present in the member 12. It is to be appreciated that the graphical comparison could be carried out on a computer or similar system, such as by the processor 34. A scale may be developed to correlate the pattern of the beam of light 28 to the amount of air flowing into the member 12, which reflects the amount of air escaping therefrom. However, since a member that leaks and a member that does not leak will have different first and second patterns, the processor 34 may be able to discriminate between the patterns with out the use of the vibration module.

While the invention has been described with reference to an exemplary embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A system for detecting leaks from a member, said system comprising:
a member having an inlet and an outlet and defining a cavity therebetween;
a gas source coupled to said inlet for charging said cavity with a gas and for continuing a flow of said gas into said cavity to maintain said charge; and
a laser vibrometer for detecting vibrations caused by continued gas flow after charging to indicate leakage of said gas from said member.

2. A system as set forth in claim 1 further comprising a vibration module coupled to said member for vibrating in response to continued gas flowing therethrough.

3. A system as set forth in claim 2 wherein said vibration module is further defined as positioned substantially perpendicular to said beam of light to reflect said beam of light.

4. A system as set forth in claim 2 wherein said vibration module further comprises a vibrator disposed therein for amplifying vibrations as said gas flows through said vibration module.

5. A system as set forth in claim 4 wherein said vibrator is selected from at least one of a flap connected at one end, a flexible membrane connected at both ends, and a vane for rotating about a shaft.

6. A system as set forth in claim 1 wherein said laser vibrometer further comprises a laser for generating a beam of light and for directing said beam of light toward said member.

7. A system as set forth in claim 6 wherein said laser vibrometer further comprises a detector for detecting said beam of light reflected by said member.

8. A system as set forth in claim 7 wherein said vibration module further comprises a reflection point for reflecting said beam of light toward said detector.

9. A system as set forth in claim 8 wherein said reflection point is further defined as being substantially planar to reflect said beam of light.

10. A system as set forth in claim 2 wherein said vibration module is further defined as coupled to said inlet.

11. A system as set forth in claim 2 wherein said vibration module is further defined as integrally formed within said member.

12. A method of detecting leaks from a member having an inlet and an outlet and defining a cavity therebetween, said method comprising the steps of:
sealing the outlet to prevent gas from escaping from the cavity;
connecting the inlet to a gas source for supplying a gas to charge the cavity;
continuing to maintain a flow of gas into the cavity after charging;
detecting vibrations caused by continued gas flow into the cavity after charging to indicate leakage of the gas from the member.

13. A method as set forth in claim 12 further comprising the step of coupling a vibration module to the member to vibrate as the continued flow of gas passes therethrough.

14. A method as set forth in claim 13 further comprising the step of directing a beam of light having a first pattern toward the vibration module and detecting the beam of light having a second pattern.

15. A method as set forth in claim 14 further comprising the step of comparing the second pattern to the first pattern to indicate a leak in the member.

16. A method as set forth in claim 13 wherein the step of coupling the vibration module to the member is further defined as coupling the vibration module to the inlet.

17. A method as set forth in claim 13 wherein the step of coupling the vibration module to the member is further defined as integrally forming the vibration module into the member.
